(19) United States
(12) Patent Application Publication
(10) Pub. No.: US 2010/0092260 A1
(43) Pub. Date: Apr. 15, 2010

(54) METHOD FOR MACHINING BLANKS IN A CLAMP

(75) Inventors: Wolf-Dieter Höhn, Meeder (DE); Frank Scherer, Frankfurt (DE)

Correspondence Address: WRB-IP LLP, 1217 KING STREET, ALEXANDRIA, VA, 22314, US

(73) Assignee: HAMUEL MASCHINENBAU GMBH &CO. KG, Meeder (DE)

(21) Appl. No.: 12/518,461

(22) PCT Filed: Nov. 21, 2007
(86) PCT No.: PCT/EP2007/010056

§ 371 Date: Jun. 10, 2009

(30) Foreign Application Priority Data
Dec. 13, 2006 (DE) 10 2006 059 227.1

(51) Int. Cl. B23Q 1/60; B23C 3/18

(52) U.S. Cl. 409/132; 29/889.7; 409/163

(57) ABSTRACT

In order to carry out complete machining of a blank on a machine tool, such as, for example, a rotary miller, the blank is held in at least one clamp during a machining step. All the functional surfaces of the workpiece (circumference and both end faces of the blank) are brought into the final required form corresponding to final use by the machine tool, in particular, the rotary miller. The blank is a blank made from metal or a ceramic material, of cylindrical, square, or polyhedral cross-section, in particular, a rectangular block or any shaped cast or forged blank. The required form is the head of a turbine blade, the blade region of the turbine blade, and the root of the turbine blade, wherein the functional surfaces of the head and root are prepared during a clamped phase on the machine tool.

### BACKGROUND AND SUMMARY

The present invention concerns a method for completely machining blanks or semi-finished work pieces with a machine tool such as a rotary miller (HSTM), components completely machined in their three-dimensional form, as well as a machine tool such as a rotary miller, for carrying out said method.

In the field of turbine blade manufacturing, these items are usually manufactured in multiple stages on multiple different machines. This means that a blank, usually a square or cylindrical rod, must go through the following completion steps:

In the first step, the blank is passed through a line milling machine in the form of a rhombus rod.

In the second step, most of the material is cut out in the actual blade area by a line milling machine. These two work steps take place on 3-axis machines.

In the third step, the turbine blade profile is machined in the blade area by copy milling machines or NC [numerically controlled] milling machines through roughing, semi-finishing, and finishing. This work step presupposes a 4- or 5-axis milling machine.

In the fourth step, the transitions from blade region to root and/or head region are produced with NC-milling. This work step presupposes a 5-axis milling machine.

In the fifth step, the root and head circumference geometry is constructed for the most part on two to four 4-axis special machines.

In the sixth and last work step, the front sides of the root and head are constructed on a 4-axis milling machine.

Between the individual steps, extensive measurement controls are needed in order to be able to comply with the narrow tolerance zone of a turbine blade. Between these individual machining steps the work piece must be reclamped by hand or with a handling system. The main reason for reclamping lies in that most milling, boring or turning machines only have the ability to carry out individual work steps, and in particular because each mounting or fixing of the work piece only permits work in a certain area. This type of manufacturing always requires a lot of handling and time.

It is problematic in this type of manufacturing, especially from the fourth step on, that the work piece has an extremely complex 3-D form, which must be brought again in the following steps into the correct clamping position in order to stay within the narrow tolerance zone. For this very complex and expensive clamping devices are needed.

With a known machine tool, the X-axis is on the back side of the frame, which means the milling spindle carries out the axis (X, Y, Z and B) as tandem axis on the front side. The work piece is clamped between two tandem X-axes and operated positive to an A-rotation axis. The turbine blade is clamped between the two axes X and U. Both axes are then operated as tandem axes. It is detrimental that tandem axes operate with slower acceleration, because one axis is always the lead axis and the other is adjusted. This is necessary because otherwise an excessive contouring error between the axes arises, which leads to the turbine blade no longer being clamped.

It is therefore the task of the present invention to make available a method for contour and front-side-machining of a blank with a machine tool such as a rotary miller, which makes it possible to manufacture the part in the fewest possible work steps and in only one clamping. In the process, the machine tool should be able to carry out different operations, such as rotary milling, milling, and boring, etc. The term “rotary miller” is thus in this context to be interpreted broadly, and refers to machine tools which are not only able to perform rotary milling, but also, for example, milling, boring, etc.

The present invention performs this task in its standard configuration by fixing and clamping a blank between a clamping medium (two- or multiple-jaw chuck or clamp adapter, etc.), that is firmly mounted to the A-rotation axis, and a counter spindle, like a tailstock center or the like, or the blank is clamped directly in the A-rotation axis by means of a special clamp adapter which is fixed to the blank outside the tool. Then this blank is delivered to the rotary miller in its final contour form as specified for its use by application of the above manufacturing method in multiple work steps. Finally, the functional areas of the root and head surface areas likewise are fabricated in this clamping phase as far as possible, and a break-off bar constructed on either side. After this machining, the completely machined part is taken from the machine tool. Both break-off bars are discarded and the part smoothed by hand in those areas.

The present invention provides both a method and a device for complete machining of a blank with a single machine tool, such as, for example, a rotary miller, which makes it possible to manufacture a part in the fewest possible work steps and with only one clamping. The machine tool is thereby able to carry out various operations such as rotary milling, milling, boring, etc.

An important feature of the invention consists in fixing and clamping the blank in one individual clamping with a standard clamping medium, such as, for example, a two- or multiple-jaw chuck or clamp adapter, etc., with or without a tailstock center or counter spindle, so that the work piece is delivered to all function areas in multiple successive work steps in its complete final form, as specified for use.

This is completely surprising because the individual work steps include rotary milling operations, such as, among other things, roughing and finishing, which exercise considerable forces on the work piece and which have formerly prevented the workman from bringing the work piece to its final form in only one clamping on one single machine. It was frequently the case that the forces generated during machining led to the impairment of the work piece or to the unsatisfactory quality of the final work piece (e.g., as a result of vibrations, torque, etc.). It now appears, however, that it is possible in one clamping with defined work steps to bring all functional surfaces of a work piece into their final form and by milling a break-off bar, avoid further work steps on additional machine tools.

The avoidance of further clampings on other machines and the use of only one machine tool, specifically a rotary miller, leads to a significant simplification of the manufacturing process and to the prevention of clamping flaws. The narrowest tolerance zones are produced thereby, because all component regions are fabricated in one clamping.

With regard to the specified complete form, which can be achieved with the proposed invention, reference is made to any component which can be obtained from a blank through the named operations. The method is particularly appropriate for the manufacture of components such as turbine blades, bladed disks, or centrifugal compressors.

According to a first preferred embodiment of the invention with regard to the blank, reference is made to a blank made of metal or ceramic material, of square, cylindrical or any cross-section form, preferably a rectangular block or a cast or forged blank. It is also possible to furnish the blank in an already semi-finished form to the rotary milling process according to the invention. Surprisingly, the process according to the invention manages to succeed even on hard-to-machine materials without loss of quality in the final formed part.

According to a further preferred embodiment of the invention, with regard to the unit mold, reference is made to a form with projecting ends on the head and root parts which are left unmachined, whereby it is particularly preferred for cuts between the projecting ends and the unit mold to be made in the first machining step. The proposed invention turns out to be appropriate for manufacturing turbine blades of any kind, whereby with regard to the unit mold in this case, reference is made to the head of the turbine blade, the blade region of the turbine blade, and the root of the turbine blade, and whereby on the head and root after contour machining in one clamping, the essential functional surfaces of the end surface parts can also be manufactured up to the narrow break-off bars.

According to a further preferred embodiment of the invention, the work piece is completely machined in one clamping. For this the work piece is fixed and clamped between the continually turning A-axis and the tailstock center on the tailstock by means of the operation of the A-axis. By means of the operation of the X-carriage, on which these machine components are mounted, the spatial directions X and a rotary motion A are generated. The two other spatial directions Y, Z and the second rotary motion B are produced by mounting the rotary milling spindle with the clamped work piece in a B-axis, and this rotary axis is moved by means of a second linear axis offset by 90°.

With regard to long work pieces all machine components stay the same except for the X-axis. It is adjusted in various gradations to the particular lengths of the work pieces. Therefore the base machine, as well as all its variants, is extremely, flexible with regard to the various length requirements of the work pieces. With large, heavy work pieces, in place of the tailstock, a second A-rotation axis counter-spindle is mounted. In this way the work piece weight to be accommodated can be doubled.

A further benefit of such a double-spindle accommodation lies in that long work pieces, which are mostly very vulnerable to vibrations, can be clamped by means of a light rotation in the opposite direction of both A-rotation axes, which lead to an increase in the rigidity of their components. Thus, they are no longer so vulnerable to vibrations. This clamping condition can be registered electronically and maintained or purposefully adjusted during the entire subsequent machining step. The corresponding torsion abutting on the work piece can be accounted for and corrected in the program controlling the milling spindle.

According to another preferred embodiment of the invention, the final complete form after the machining steps can be cleaned and/or measured and if necessary corrected, because the work piece doesn't lose its clamping position. The corresponding means for carrying out this step, which can also cover the component material code, can be carried out preferably on the same machine tool, specifically a rotary miller, which increases the precision of the work piece.

The present invention turns out to be particularly appropriate for the manufacture of turbine blades with or without a shroud-band. Particularly with regard to the manufacture of such large components with surfaces in the area of N4 to N5, with tolerances of ±0.003 mm, with a length in the area of 20 to 2500 mm, with a rotating diameter of 10 to 600 mm and a weight of 1 to 200 kg, the present invention can be employed on a single machine tool, specifically a rotary miller, without problems of stability (despite great leverage) or accessibility appearing due to the machine head.

Because the base machine is built from scratch as a modular construction system machine, the field of application of the machine tool, such as a rotary miller, through insertion of modular construction components, such as, for example, a rotary table or angle frame, also allows itself to be adapted to short, thick work pieces easily. Thus, the application field of this machine is not limited to short work pieces, or long, thin work pieces, but it can also produce very thick, short semi-finished or untreated work pieces, such as bladed disks or centrifugal compressors, ideally in one clamping.

It is essential that the turbine blade or other work piece be clamped only between the U-axis and the A-axis. Both axes are mounted on the X-axis. Only the X-axis moves for machining as a simple linear axis and not a tandem axis. This way very high acceleration can be achieved. The U-axis has only the static function of a clamp axis. All functional surfaces of the work piece, in particular, of a turbine blade, are produced in one clamping. In order to make a turbine blade ready for installation, after breaking off the bars a relief groove is automatically milled on the root or can be polished by hand. The machine tool is constructed in a modular way, so that by a simple modulation of its construction components, bladed disks or centrifugal compressors can also be produced.

The turbine blade is held, if at all, only on one side in any clamping medium (two- or multiple-jaw chuck, etc.). On the other side it is held by means of a tailstock which can accommodate the most varied center units, or a counter-spindle. There is only one collecting channel in front of the machine and not in the middle or behind the frame. The machine is designed so that it can run by means of hand loading or fully automated bar loading.

The two spatial coordinates Y, Z and a rotary motion B, which the milling spindle carries out in the rotary miller, were chosen or arranged so that an extremely fast tool change is possible. Because the milling spindle has to carry out no X-motion whatsoever, the clamp-to-clamp time remains constant, which results in a significant savings of time, when many work pieces are employed on account of the complex form of the work piece.

With regard to the known machine, in contrast, three spatial coordinates X, Y, Z and a rotary motion B are necessary for changing work pieces, whereby the X-motion must travel an extremely long way, which moreover is not constant. Therefore the clamp-to-clamp time is higher by a factor of 8 than in the case of the machine according to the invention.

### BRIEF DESCRIPTION OF THE DRAWINGS

Further preferred embodiments of the method according to the invention or the machine are the subject of further claims and described below.

The invention will be explained in detail below by means of embodiment examples in connection with the drawings. The following is shown:

FIG. 1 shows a milling machine with 11 axes in perspective;

FIG. 2 shows a different perspective of the milling machine according to FIG. 1, with double A axes;

FIG. 3 shows a variant of the milling machine, generated modularly, according to FIG. 2, for the machining of tall, cylindrical or discoidal work pieces of medium diameter, with a compensator and an additional C-rotation axis;

FIG. 4 shows a variant of the milling machine, generated modularly, according to FIG. 1, for the machining of very large, thin, discoidal work pieces of medium height, with a C-rotation axis, and angle table and an additional D-rotation axis;

FIG. 5 shows a perspective of the loading and unloading mechanism from the side;

FIG. 6 shows a perspective of the loading and unloading mechanism from above;

FIG. 7 shows a perspective of the machine with an automated bar as the loading and unloading mechanism; and

FIG. 8-13 each show a spatial representation and schematic front perspective of a turbine blade to be machined in multiple machining steps.

### DETAILED DESCRIPTION

In the descriptions and drawings, the following designations of the component parts are used:
G Base frame of the machine
FBY Rear Y-bedway
GSY Y-base carriage
FBZ Z-bedway
GSZ Z-base carriage
RAB B-rotation axis
HSSP High frequency milling spindle
FBX Front X-bedway
GSX X-base carriage
RAAR Right A-rotation axis
FBU U-bedway
GSU U-base carriage
RST Tailstock
PN Sleeve—tailstock
PS Sleeve center
WKZM Tool magazine
DAWG Twin-arm tool gripper
DH Automatic traveling system for the twin-arm gripper
DW Tool magazine travel arm
SPK Collecting channel
RAAL Left A-rotation axis
GSXR X-rotation axis carriage
RAC C-rotation axis
WE Winder
RAD D-rotation axis
RSS D-rotation axis clamping medium

The illustrated machining tool, for example a high-speed rotary miller (HSTM), is built on the basic concept of the machine, that work pieces with a swing of up to 600 mm and a length of up to 2,400 mm can be manufactured using the “rotary milling” manufacturing process and all its variants.

In a further variant of the concept, based on the basic concept, work pieces with a swing of up to 1,200 mm and a length of up to 800 mm can be manufactured using the “rotary milling” manufacturing process and all its variants. These work pieces can be either of a rotationally symmetrical and complex nature or free in their sectional geometry, such as, for example, the whole spectrum of turbine blades, and also centrifugal compressors and bladed disks. Through the use of multiple-edge milling tools and such, an increase in the specific volume of metal cuttings is achieved in comparison to single-edged work pieces.

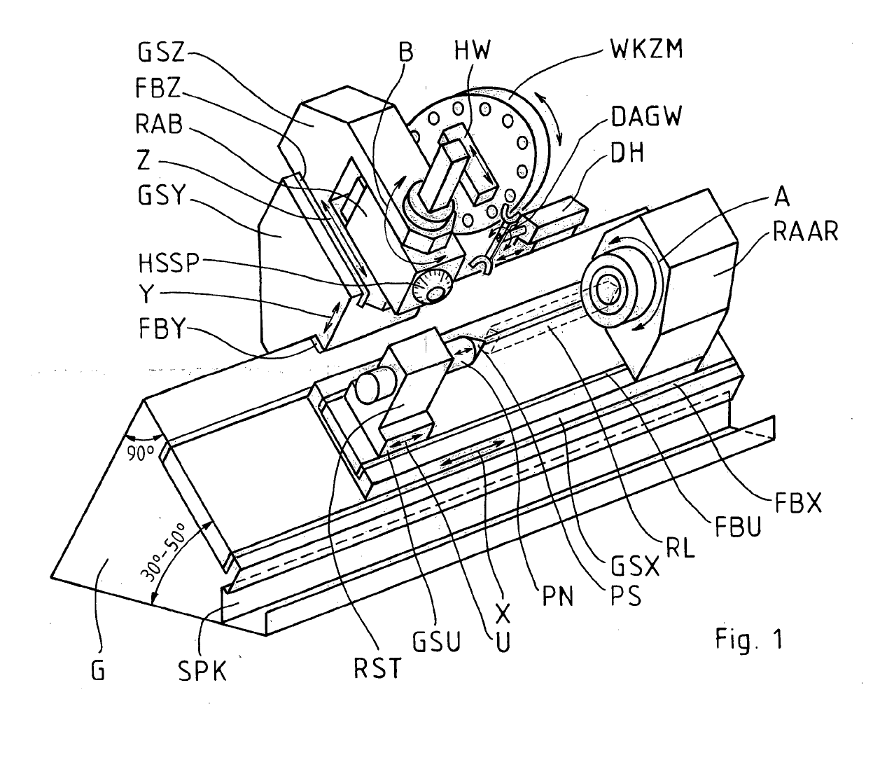

FIG. 1 shows the fundamental concept of a HSTM-machine tool in perspective. The HSTM-machine tool has a base frame G. The length “X” of the base frame G is the single variable in all model variants and types. It is derived from the lengths of the work pieces to be machined, for example, turbine blades.

By supplementing it with similar and differing machine components, this rotary miller is serviceable for a multiplicity of other work piece needs. Most importantly, this variable design saves manufacturing costs.

The smallest base frame length is configured in order to clamp a blank RL which can produce a turbine blade with a maximum length of 300 mm, or a bladed disk or centrifugal compressor with a diameter of up to 500 mm. The base frame length in “X” is chosen so that, with a milling spindle HSSP rotated at 90°, a centering device, pivot or other clamp support can be produced on other free unprocessed parts on a blank of up to 500 mm in length, clamped in the work piece rotation axis RAAR.

For longer turbine blades the base frame is only adjusted in length by a factor of 2×(“X”=300), for example, for a turbine blade with Lx=1000 and base length. Lo/300=3600 mm for a 300 machine: Lo/300=3600 mm plus 2×(1000−300), thus 3600 mm+1400 mm=5000 mm, and so on.

On the back of the base frame G in the middle of the base frame G in a defined angle, which lies between 30 and 50°, a bedway FBY for a base carriage unit GSY is attached. The Y-travel “Y” is operated with this.

This base carriage unit GSY is constructed so that, a bedway FBZ, on which the Z-RAM GSZ is mounted, is attached at 90° to the “Y” path. The Z-travel “A” is operated with this. The Z-RAM GSZ is constructed in the machine chamber as forkhead-pivot RAB, in which the high frequency fast mode spindle HSSP is mounted so that a swinging motion can be carried out around the B-rotation axis “B” of more than ±90°.

The high frequency fast mode spindle HSSP and thus the milling work piece make the axis movements “Y,” “Z” and “B.” Both bedways FBX, on which the carriage unit GSX moves, are placed on the front side of the base frame G, which stands at the exact angle of 90° to the bedway FBY.

The work piece rotation axis RAAR is firmly mounted on the carriage unit GSX, on the right side. It forms the turbine blade pivot “A.” This pivot is constructed with a standard HSK cutting site to accommodate the clamp adapter or the multiple jaw chuck. The work piece rotation axis RAAR makes a continuous angular motion (360° continuously).

Both bedways FBU, on which the carriage unit GSU moves are placed in the carriage unit GSX in front of the work piece rotation axis RAAR. It operates the U-travel “U” to clamp the various turbine blade lengths.

Normally, the tailstock is firmly mounted on the carriage unit GSU. It has a sleeve PN, which has a second clamp travel of 30-180 mm, depending on the turbine blade length. The sleeve center PS is constructed so that it has either a fixed or live center, a chuck or clamping mandrel, or both. With this the blank RL is mounted and held on the left side. The blank thus makes the axis movements “X” and “A.”

The collecting channel SPK is integrated in front of the bedways FBX on the lower frame edge. By placing the X-frame surface diagonally, all cuttings end up without further assistance automatically in the collecting channel.

With the workpiece-rotational axis RAAR and the tailstock RST/PN the clamped unmachined parts can be run through both the rotary operation and the milling operation. The high frequency fast mode spindle HSSP is fixed in the B-rotation axis RAB with a fast clamping system. The energy and signal transfer from the machine to the high frequency fast mode spindle is done via a plug-and-socket cutting site.

To the right (as shown) or left, alongside the bedway FBY, on the rear base frame G, a disk magazine SM and a twin-arm gripper changer are mounted. The twin-arm gripper changer makes a traveling movement DH and a rotational movement of ±90°.

A change of tool proceeds as follows: The high frequency fast mode spindle HSSP is driven to the tool change point WKZWP by both linear movements “Y” and “Z” plus a rotational movement in “B,” so that it is positioned in front of the twin-arm gripper changer DAGW which has been rotated 90°. Now the high frequency fast mode spindle HSSP drives a defined “−Z”—travel and thus lays the old tool on the one side of the open twin-arm gripper changer DAGW. The clamping of the tool WKZ is unlocked in the high frequency fast mode spindle HSSP and withdrawn by means of a defined “−H1”—backwards travel of the twin-arm gripper DH. After this the twin-arm gripper changer DAGW is rotated 180° and by means of a defined “+H1”—forward travel of the twin-arm gripper DH positioned in the high frequency fast mode spindle HSSP. After clamping the tool WKZ, the high frequency fast mode spindle HSSP drives forward with a defined “+Z”—travel, whereby the tool WKZ is withdrawn from the gripper. The high frequency fast mode spindle HSSP moves by means of the “Y,” “Z”—travel and “B”—rotation to a new operation point.

The twin-arm gripper is driven by means of a defined “−H2”—return stroke DH far enough to the rear that the tool WKZ arrives at an empty magazine spot of the disk magazine SM and is locked there.

The magazine disk of the disk magazine SM pulls, by means of a defined “−ZZ”—travel, the tool WKZ from the twin-arm gripper. With a prescribed rotation of the magazine disk a new tool WKZ is brought into transfer position UP. With a defined “+ZZ”—travel of the disk magazine, the tool WKZ is positioned and locked in the twin-arm gripper. The twin-arm gripper DAWG travels forward to the waiting point of the system, where its automatic lifting system makes a defined “+H3”—travel, by means of which the tool WKZ is pulled from its position in the disk magazine SM. In this way a change of tool may be accomplished in about 5 seconds.

The machine's expanded versions will be described next.

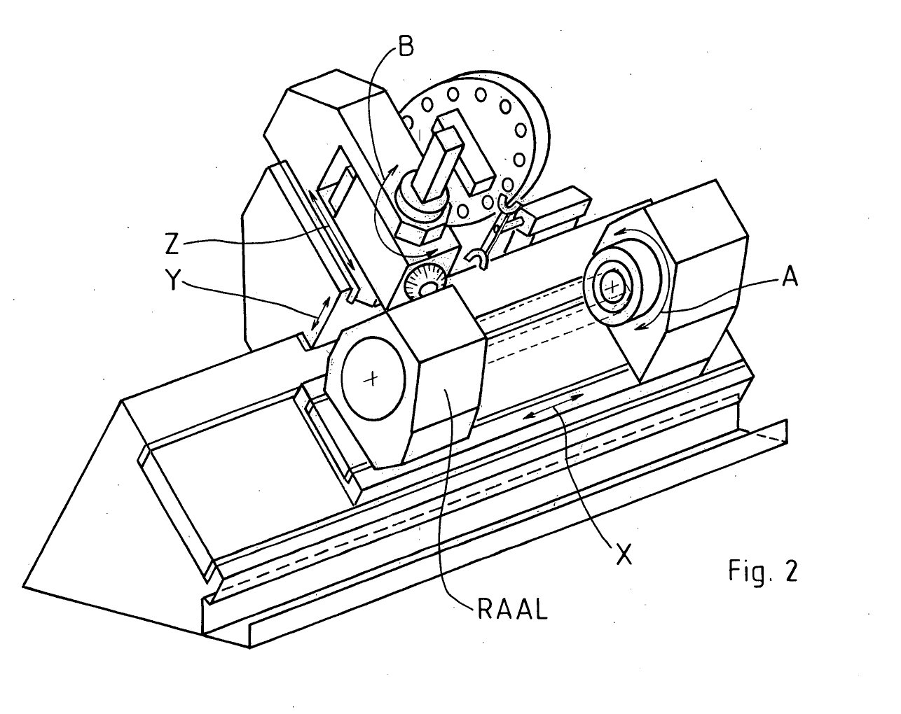

Double-A Axis Machine:
FIG. 2 shows this expanded version. Here in place of a tailstock, a second workpiece rotation axis RAAL is mounted, which is identical in construction to the workpiece rotation axis RAAR; this way the blank can be moved by both axes. Furthermore, thanks to the varying control of these two rotation axes, the blank can undergo torsional stress, which, for thin blanks, leads to strengthening of the blank, even before both axes are activated synchronously.

Thanks to the two workpiece rotation axes RAAR and RAAL, the workpiece weight 160 kg can be doubled. In this way this expanded version is a significant improvement for machine types which predominantly produce heavy blanks.

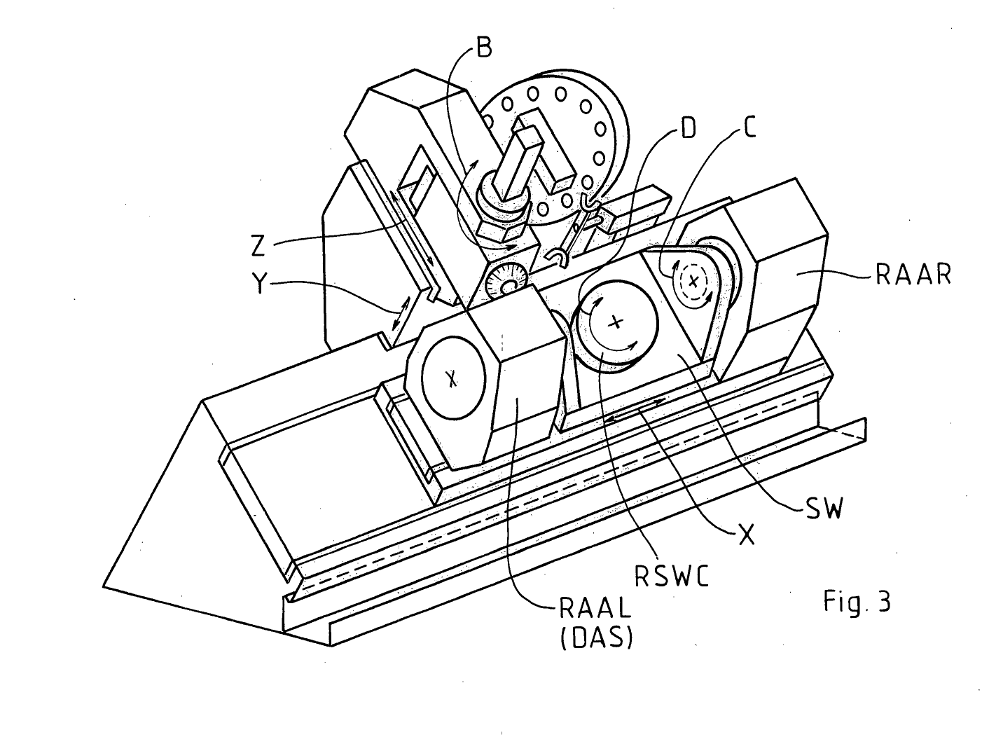

Centrifugal Compressor Machine:
FIG. 3 shows the first expanded version for a tall, medium-diameter, cylindrical or disk-shaped workpiece up to 120 kg in weight, such as, for example, centrifugal compressors, etc. In this expanded version a compensator WP is mounted between the two rotation axes RAAR and RAAL. Next, the rotation clamping system RSS is mounted on the C-rotation axis RAC, which can accommodate a workpiece up to a diameter of 800 mm and a height of 500 mm.

For a less efficient variation the second A-rotation axis RAAL can be replaced with an unpowered rotary support DAS. The two A-rotation axes RAAR and RAAL or the A-rotation axis RAAR with the opposing, unpowered rotary support DAS make an angular motion of 150° or more. The C-rotation axis RAC makes a continuous angular motion (360° continuously).

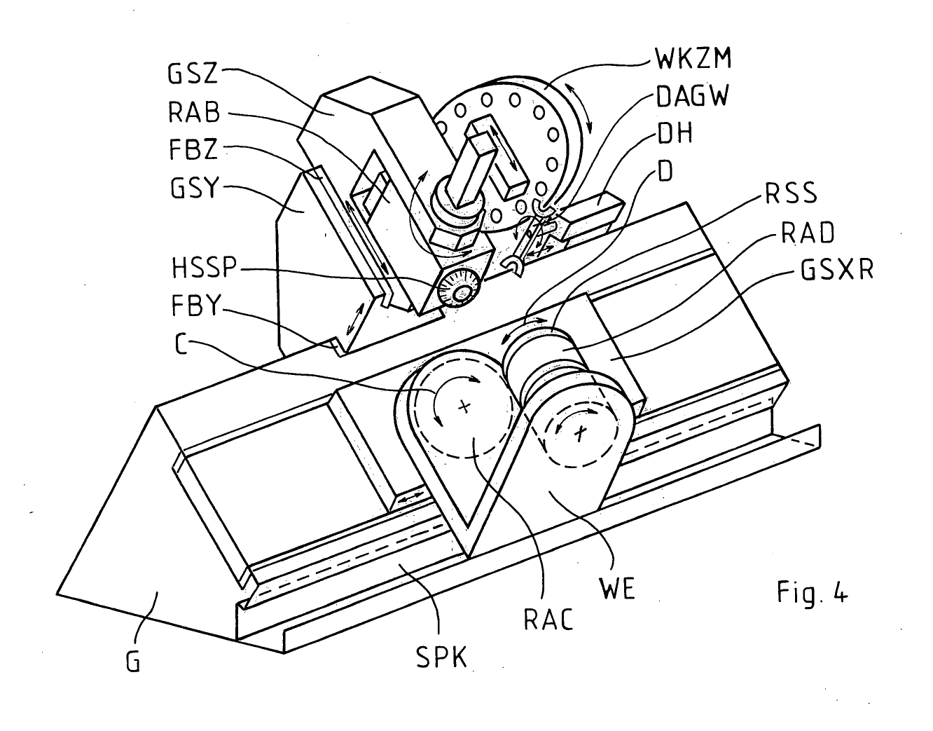

Bladed Disk Machine:
FIG. 4 shows a second expanded version for thin, disk-shaped workpieces that are of very large diameter, of medium height, and up to 80 kg in weight, such as, for example, bladed disks, etc. In this expanded version, in place of the carriage unit GSX, on which the workpiece rotation axes RAAR and the carriage unit GSU with the tailstock RST are mounted, a carriage unit GSXR is mounted, in which the above-mentioned C-rotation axis RAC is integrated. On this C-rotation axis RAC, at an angle of 90°, the D-rotation axis RAD is mounted, on which the various rotation clamping systems are mounted, which can accommodate workpieces up to a diameter of 1,200 mm and a height of 400 mm. Disk machining is carried out here preferably, such as, for example, bladed disks.

The C-rotation axis RAC makes an angular motion of ±120° or more. The D-rotation axis RAD makes a continuous angular motion (360° continuously).

For the machine variants in FIGS. 3 and 4, in a simple embodiment, the B-rotation axis RAB can be dispensed with.

Expanded versions of automation will be described next.

Loading and Unloading Mechanisms:
The basic machine as well as the expanded versions with counter spindle, or the machine designed to machine bladed disks or centrifugal compressors, is normally loaded by hand. The workpiece assembly procedure can be automated in all these machine types through the use of various loading and unloading units. These are:

a.) Side-loading (for example right-side) (FIG. 5): a twin-arm gripper mounted on a linear guideway above the workpiece rotation axis RAAR is mounted through the right cabinet wall. This moves either the blank or the finished workpiece directly or with the help of an adapter from the blank magazine to the clamp point receptacle in the workpiece rotation axis RAAR.

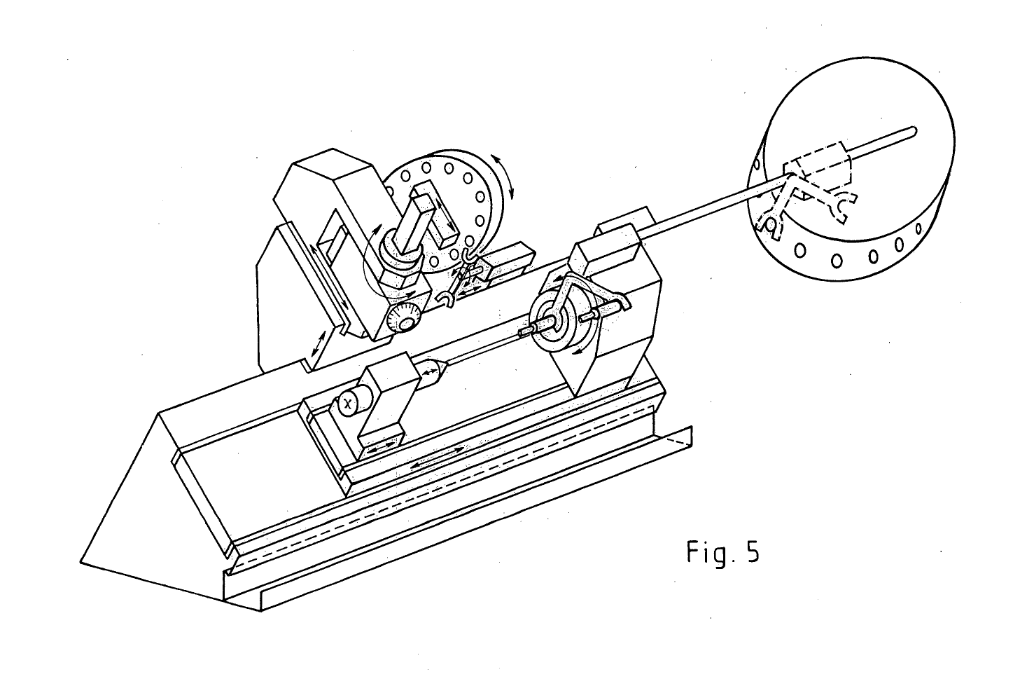

b.) Loading from above (FIG. 6): loading from above is carried out by means of a linear handling system. On the handling arm, which is driven down into the machine chamber through the opening in the top, a twin-arm gripper is mounted for small workpieces. This moves either the blank or the finished workpiece directly or with the help of an adapter from the blank magazine to the clamp point receptacle in the workpiece rotation axis RAAR.

With large, heavy workpieces loading is carried out by means of two handling arms.

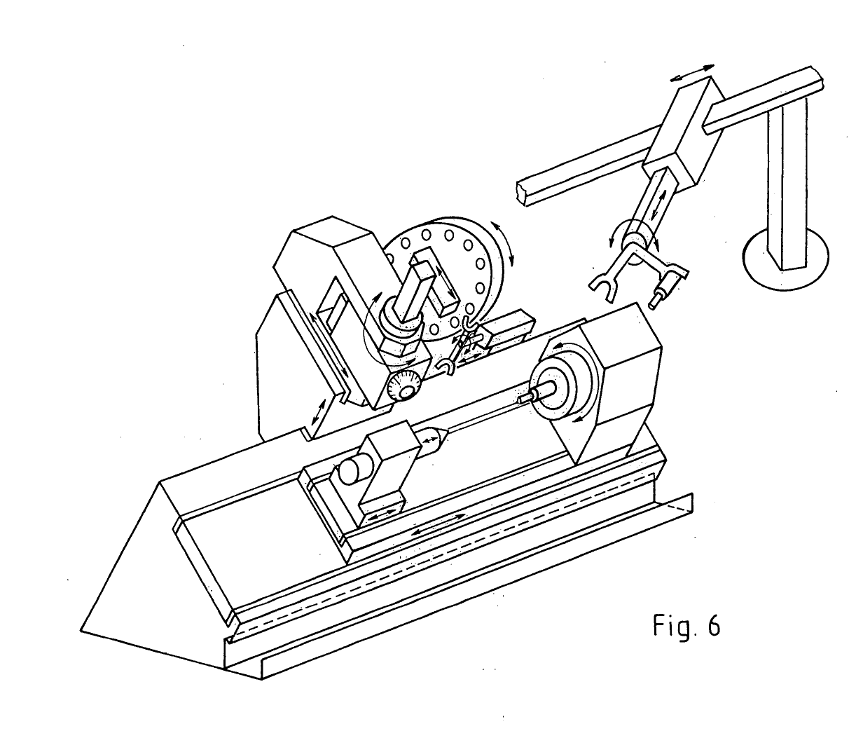

c.) Loading with an automated bar feeder (FIG. 7): for small turbine blades (<500 mm long).behind the high frequency fast mode spindle HSSP on the carriage unit (GSX) a customary automated bar feeder STWA is mounted which moves with it. Change of blanks is carried out as follows: the finished turbine blade is detached with an appropriate tool (e.g., end milling cutter) from the blank bar RTS which is clamped in the passageway chuck DGF of the turbine blade rotation axis RAAR, and picked up by means of a compensator WP which is secured under the turbine blade.

Next, the passageway chuck DGF is opened and the blank bar RTS is moved forward a defined travel “L” (=a function of the turbine blade length) by means of the automated bar feeder STWA. The blank bar RTS is clamped by closing the passageway chuck DGF. After this, by mean of a high frequency fast mode spindle HSSP rotated 90° on the open end of the blank bar RTS, a new clamp or fixing center (centering device, pivot or other clamp support) is produced.

The blank RTS is then clamped between the turbine blade rotation axis RAAR and the tailstock RST by moving the tailstock RST in the newly machined clamp or fixing center. This expanded version is primarily important for small short turbine blades.

The usual bar lengths used here are up to 6 m.

d.) The loading and unloading mechanisms in a.) and b.) can also be used to change bladed disks or centrifugal compressors. Special gripper systems are constructed on the handling arms or twin arms.

These loading and unloading mechanisms are also used in other machine variations. In this case only the grapples are adjusted to the contour of each workpiece.

The loading and unloading of the machine is carried out as follows: a blank of any form is placed, by hand or by means of a handling system, in the rotary miller, which can also stand in a flexible carriage, and after machining is removed with the same means of transport.

For this the Following Various Methods are Used:
For the loading and unloading of blanks by means of a clamp adapter, the blank is fixed to a standard clamp adapter outside of the machine tool by hand or by means of an automatically controlled clamping system (with or without surfaces that support fixing or clamping). For loading the machine, the handling system always grips only the standarized clamp adapter and brings this like a tool to the receiver point of the A-rotation axis, where it is fixed and clamped like a tool by means of an HSK cutting site.

The benefit consists in a simple embodiment of the grapples of the handling system. The gripper travel is always the same. The control is simple. Drawbacks consist in that with small, light workpieces the heavy clamp adapter must always be handled. With heavy and long workpieces two clamp adapters must be used. The labor cost independent of the machine is high. The additional necessary surfaces that support fixing or clamping are an additional soft element in the overall system. Suitable surfaces that support clamping mainly include a parallel bar, dovetail fixing, or cylinder fixing.

For loading and unloading of blanks without a clamp adapter the blank is delivered directly by hand or by means of an automatically controlled gripper-handling system with or without surfaces that support fixing or clamping, in the two- or multiple-jaw chuck clamping system or nonstandard clamping device. For loading the machine, the handling system directly grips the blank with parallel grapples, to be precise, either directly on the outside of the blank or on its surfaces designed to support fixing, and moves the blank from above into the clamping medium.

After clamping the blank in the clamping medium, the counter spindle, which is needed to fix and stabilize the blank in the machining process, if it was not previously processed on the blank, is manufactured on the machine tool by means of an HSSP rotated 90° and other necessary tools.

Next, the tailstock with its tailstock center, which is either standing or revolving, or another fixing and clamping [device], is lifted by the U-carriage unit so that the blank is firmly clamped between the tailstock and the A-rotation axis. By means of an additional tailstock sleeve PN, which is, however, not necessarily required, this clamp force can be changed during the clamping process to positively influence the oscillation sensitivity and rigidity characteristics of the unstable blank. If a pivot is used for fixing and clamping, the blank can even be placed in process.

For long or very heavy blanks, two parallel grippers can be used. For blanks with processed fixing points the grippers have a special helpful form that prevents droppage and should additionally ensure better fixing.

For unloading a finished workpiece the same grippers are used. The workpiece is gripped in the engagement system on its parallel surfaces on the clamping medium, the clamp is loosened and the finished workpiece is lifted up or to the side and out. With long or heavy finished workpieces two parallel grippers can be used. The workpiece is gripped either on both parallel surfaces on the clamping medium or on the breakoff bar surfaces, and so on. After that the clamping is loosened and the finished workpiece lifted up or to the side and out.

To make both procedures time-efficient, a twin-arm gripper is often used, with which the finished workpiece is lifted out from the clamping medium and the blank immediately brought into its clamping position through a 90 to 360° rotation of the twin-arm gripper. Advantages consist in the fact that no heavy clamp adapter is needed. The labor cost outside of the machine is low. Control is simple. A drawback consists in that the gripper structure is somewhat complex, because it is necessary to attach surfaces that support fixing.

Cast or forged blanks can be loaded and unloaded according to the same principle. In order to be able to simplify the gripper structure, these blanks are often fitted with supporting surfaces.

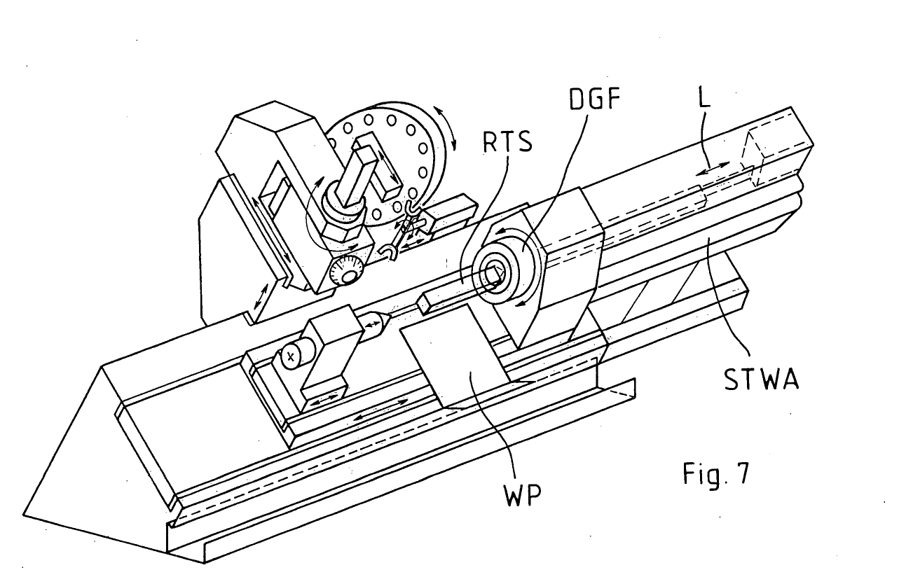

In a rotary miller the following manufacturing steps are carried out, each of which is depicted in FIGS. 8-13 by means of a turbine blade in a spatial representation and schematic front perspective. FIG. 8-11 show the machining of a turbine blade which is clamped on both ends in a chuck.

A) In the first machining step, in the clamping between the A-rotation axis and the U-fixing and clamp axis, all roughing operations are carried out except for a defined allowance on the end contour of the rhombus (FIG. 8). For a turbine blade, maximum contours on the root, canal and head region are processed. For this roughing tools are clamped in the high frequency milling spindle HSSP using an integrated tool changer. Rough milling of any kind itself is carried out by means of an NC program.

B) In the second step, the canal region of the turbine blade is milled out (FIG. 9). In most cases the same tools can be used for this. These roughing operations can be carried out both in multiple steps, as described, and in a single step using efficient milling technology such as spiral (helical) milling.

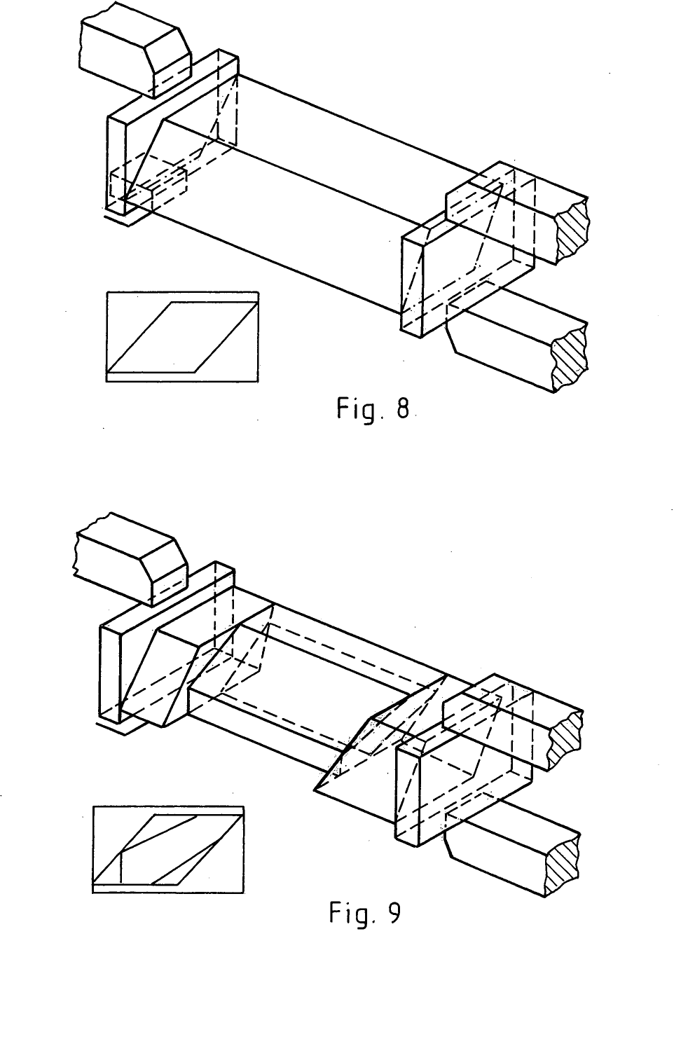

C) In the third step (FIG. 10), the profile contour of the turbine blade leaf is roughed using a small-diameter tool. The allowance is blade-type dependent and can reach up to 2 mm. With spiral (helical) milling, this is carried out very similarly to roughing, with a smaller tool diameter, however.

D) In the fourth step (FIG. 10), the already clamped rough milled turbine blade is brought to its final contour through spiral (helical) milling and linear milling using the pre-finishing tool with a constant allowance (plus 0.2 to 1.2 mm). The allowance is blade-type dependent. With different turbine blade types steps B and C may be omitted.

E) In the fifth step (FIG. 10), the complete turbine blade canal through spiral (helical) milling is brought to the desired contour and surface quality using the finishing tool.

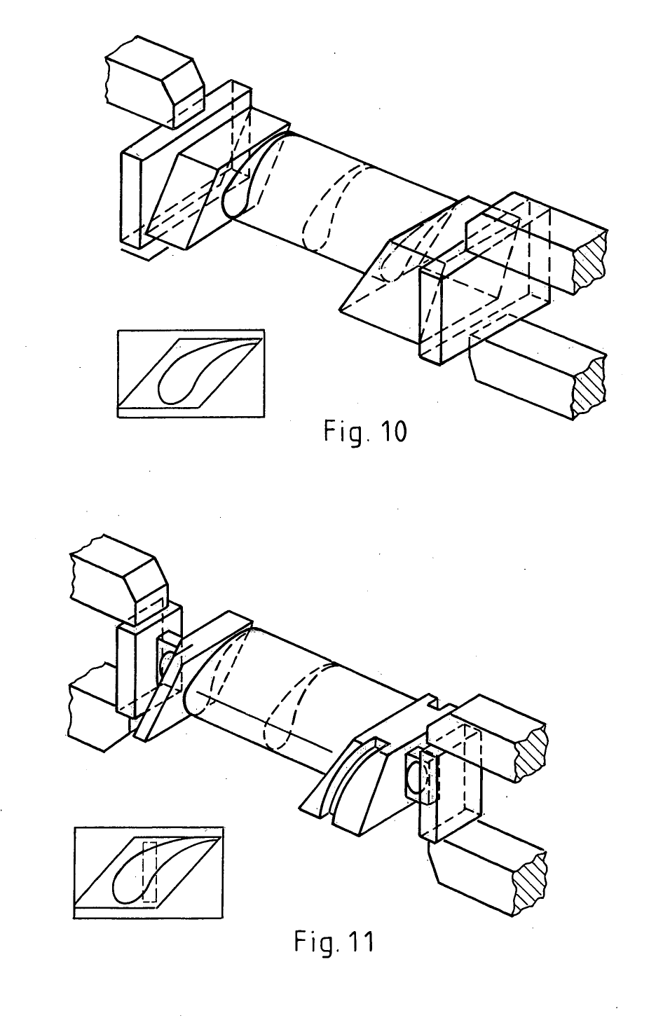

F) In the sixth step, the rhombus surfaces are processed on the head and root inclusive of the turbine blade attachment and leak proof parts, i.e., the functional surfaces of the root geometry (H-root, etc.) are already processed in this step (FIG. 11).

G) Next, a measurement of the turbine blade is performed by means of a position or contour measuring system (feeler or laser measurement system). The measurement data for the documentation are prepared and, if necessary, corrected data for the same or the next turbine blade are compiled and relayed to the controls or for inclusion in the corresponding NC program. After this operation, the turbine blade is finished except for the end faces on the head and root.

H) In the third to last step, the break off bars on the head and root are milled off with a small end mill.

I) In the second to last step, the front side functional surfaces on the head and root parts are machined.

K) In the last step, the break off bar is weakened, if necessary, by two elongated mounting holes.

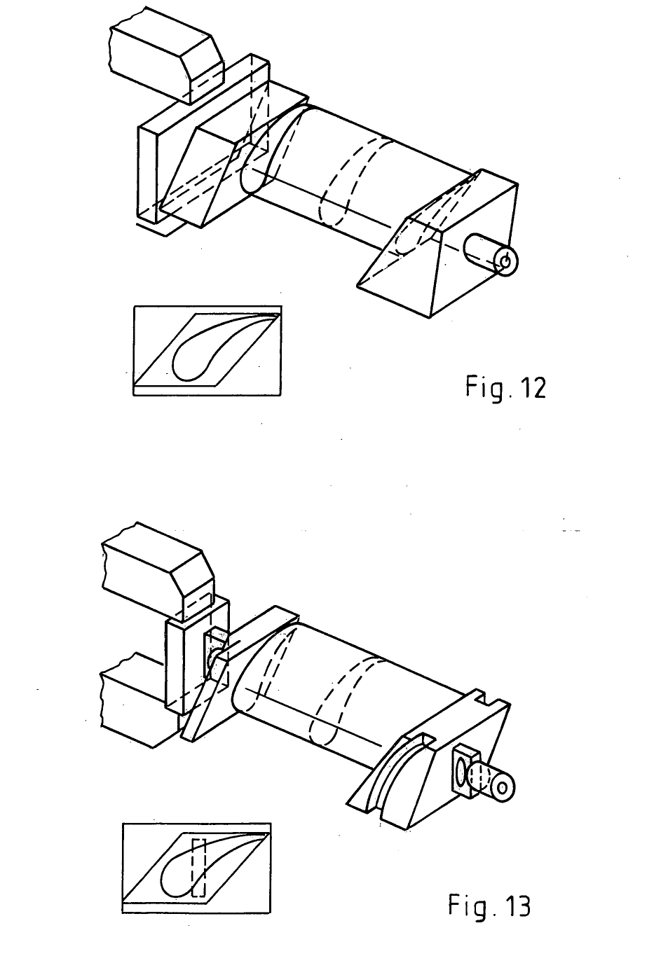

FIG. 12 shows the machining steps C), D) and E) and FIG. 13 the machining steps H), I), and K) for a turbine blade, one of whose ends is prepared for support with a tailstock center.

1. Method for completely machining a blank with a machine tool, comprising, in a machining step, holding the blank in at least one clamp, and manufacturing all functional surfaces of the (blank, including a circumference and both end surfaces thereof, by the machine tool.

2. Method according to claim 1, wherein the blank is a blank made of metal or ceramic material and of cylindrical or square or polyhedral cross-section.

3. Method according to claim 1, wherein the final form of the blank is a turbine blade.

4. Method according to claim 1, comprising machining the workpiece in one machining step by one milling spindle which is movable in two spatial directions and which carries a rotary spindle for attaching a tool, and moving the blank in a spatial direction and rotating the blank about a rotary A-axis.

5. Method according to claim 1, wherein long, thin blanks are clamped between two A-axes with or without an adapter.

6. Method according to claim 1, wherein for very short workpieces, a standard automated bar feeder is mounted to carry out bar machining.

7. Method according to claim 1, comprising changing modular built-on machine components for machining of blanks of different dimensions.

8. Machine tool for carrying out a method for completely machining a blank comprising a base frame, a base carriage unit, and a Z-base carriage, which carries a machining spindle, as well as with an X-bedway, wherein on the X-bedway, an X-base carriage is maneuverable, and on the X-base carriage, a continuously rotating A-axis and a clamping medium which is movable lengthwise are mounted, between which the workpiece is tensible.

9. Machine tool according to claim 8, wherein the clamping medium which is movable lengthwise is a tailstock.
